(19) United States
(12) Patent Application Publication
(10) Pub. No.: US 2009/0113419 A1
(43) Pub. Date: Apr. 30, 2009

(54) SYSTEM AND METHOD FOR A LIGHT WEIGHT SERVER INSTALLER

(75) Inventors: Akbar Ali Ansari, Nashua, NH (US); Sabrina Reynoso, Nashua, NH (US); David Cabelus, New Hope, PA (US)

Correspondence Address: Fliesler Meyer LLP, 650 California Street, 14th Floor, San Francisco, CA, 94108, US

(73) Assignee: BEA SYSTEMS, INC., Redwood Shores, CA (US)

(21) Appl. No.: 12/259,229

(22) Filed: Oct. 27, 2008

Related U.S. Application Data
(60) Provisional application No. 60/982,700, filed on Oct. 25, 2007.

(51) Int. Cl. G06F 9/445

(52) U.S. Cl. 717/178; 717/174

(57) ABSTRACT

In one embodiment a light weight server installer is provided which enables a user to install a Java Platform Enterprise Edition compatible application server with no additional functionality. The user can then select the functionality he or she requires and the light weight server installer installs only the components necessary to implement the selected functionality. In another embodiment the user uses a graphical user interface to make his or her selections. In another embodiment the light weight server installer is an internet installer, enabling the user to download over the internet only the components necessary to implement the selected functionality.

### CLAIM OF PRIORITY

This application claims benefit to the following U.S. Provisional Patent Application:

U.S. Provisional Patent Application No. 60/982,700 entitled “System and Method for a Light Weight Server Installer,” by Akbar Ali Ansari, filed Oct. 25, 2007, Attorney Docket No. ORACL-02291US0.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is generally related to Java-based application server environments and in particular to a system and method for a server installer.

### SUMMARY

Disclosed herein is a system and method for a light weight server installer. Existing application server installers limit the user to selecting which software product to install. This provides an inadequate level of control to users who require only a subset of the functionalities available in a given software product. This leaves the user with functionality that he or she may not use, wasting disk space and install/startup time. This also increases the size of the installer and the size of the footprint of the installed application server. For example, in the case of Weblogic Server by Oracle Corporation of Redwood Shores, Calif., the installer requires about 700 MB of disk space and the minimum installation requires 525 MB. A light weight server installer with finer grained installation options can be useful. In one embodiment a light weight server installer is provided which can enable a user to install an application server, such as a Java Platform Enterprise Edition compatible application server with no additional functionality. The user can then select the functionality he or she requires and the light weight server installer can install only the components necessary to implement the selected functionality. In another embodiment the user can use a graphical user interface to make his or her selections. In another embodiment the light weight server installer is an internet installer, enabling the user to download over the internet only the components necessary to implement the selected functionality.

### BRIEF DESCRIPTION OF THE FIGURES

FIG. 1 shows a Graphical User Interface (GUI) in accordance with an embodiment.

FIG. 2 shows an Internet Installer in accordance with an embodiment.

FIG. 3 shows an Enhanced Package Installer in accordance with an embodiment.

FIG. 4 shows a flowchart of a Developer use case in accordance with an embodiment.

FIG. 5 shows a flowchart of an Administrator use case in accordance with an embodiment.

### DETAILED DESCRIPTION

### Light Weight Server Installer

A light weight server installer can provide finer grained installation options in order to provide a smaller download and installation footprint. The light weight server installer can include technologies essential for application server runtime and production execution as well as optional components.

The light weight server installer can support component installations and uninstallations that allow the user to install additional components, to add functionality, or uninstall currently installed components, to remove functionality. These finer grained installation options enable the user to select which components of the application server to install to limit the installation to the user's needs.

For example: Options A, B, and C are available for installation. The customer can install option A in the initial installation. Later, the customer can install options B and C in addition to option A which was already installed. Likewise, if options A, B, and C are installed, the user can uninstall option B at a later time, provided that the remaining options do not depend on option B.

One embodiment includes a light weight server installer. The light weight server installer can include a plurality of selectable options including a core application server and a plurality of optional components. The optional components can include an administration console, at least one library, and at least one driver. In one embodiment, the light weight server installer installs only the selectable options selected by a user.

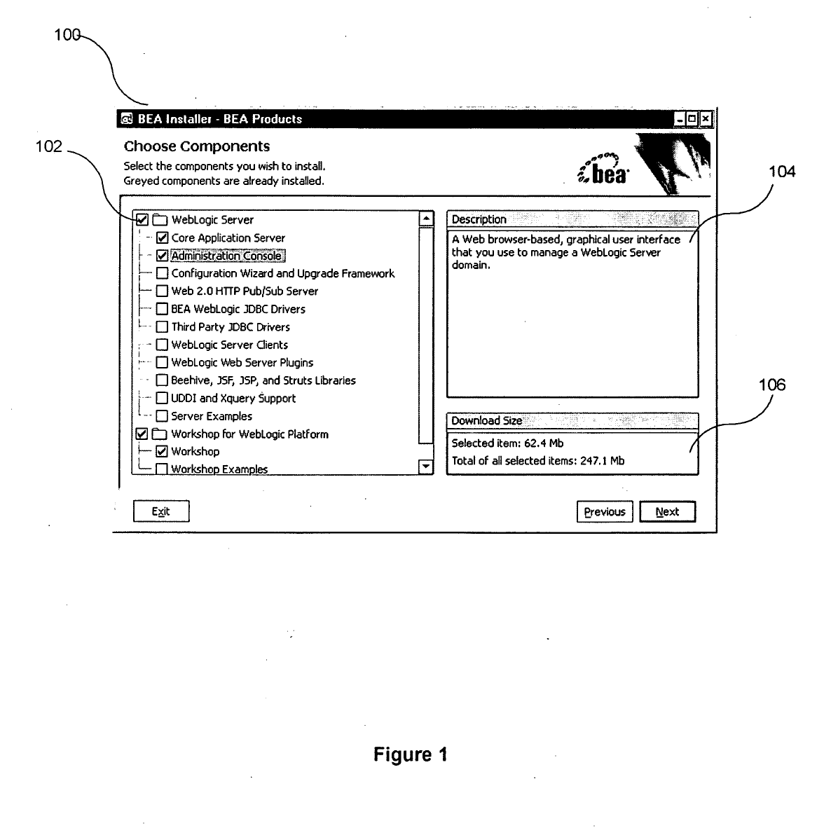

FIG. 1 shows graphical user interface (GUI) 100 in accordance with an embodiment. Frame 102 lists the selectable options available. In Frame 102, the Core Application Server and Administration Console under WebLogic Server and Workshop under Workshop for WebLogic Platform are selected; Administration Console is highlighted. Frame 104 contains a description of the highlighted selectable option; here it shows a description for Administration Console. Frame 106 shows the disk space required to install the highlighted item and the disk space required to install all selected items.

### Enhanced Package Installer

In one embodiment, the light weight server installer is an enhanced package installer which can provide more install options for an application server. A package installer can contain all of the software necessary to install an application server and all of its options. With a package installer, the user can download the entire installer before running the installation program. Package installers can also be placed on a DVD or other storage media for physical distribution. The enhanced package installer can also be used to install additional software components in an existing application server installation. Additionally, an enhanced package uninstaller can individually uninstall previously installed components. The enhanced package installer can show the disk space required to install a component.

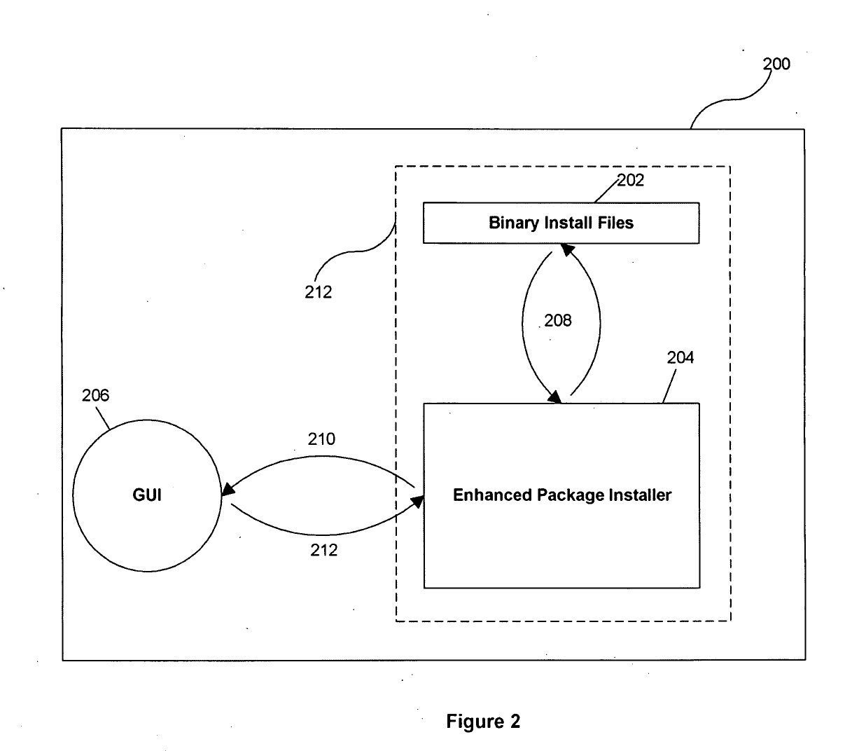

FIG. 2 shows an enhanced package installer in accordance with an embodiment. The enhanced package installer 204 can be delivered to computer 200 via a DVD or other computer readable storage medium 212. The enhanced package installer can come with all of the software needed to install all selectable options in the form of binary install files 202. In this example, the user can select 210 from among the selectable options presented using GUI 206. The enhanced package installer using 208 the binary install files then installs only those selectable options selected by the user.

In one embodiment, a light weight server installer can receive a selection from a plurality of selectable options. The plurality of selectable options can include a core application server and a plurality of optional components. The plurality of optional components can include an administration console, at least one library and at least one driver. The light weight server installer can install the selection of selectable options.

In another embodiment, a light weight server installer can be stored on a computer readable medium. When executed on a computer, the light weight server installer can receive a selection from a plurality of selectable options. The plurality of selectable options can include a core application server and a plurality of optional components. The plurality of optional components can include an administration console, at least one library and at least one driver. The light weight server installer can install the selection of selectable options.

In an embodiment, the light weight server installer can have inter-dependencies on selectable components built into the User Interface layer. For example a user trying to install an administration console must have the core application server option chosen or downloaded previously. All of the options can independently depend on the core application server. The interdependencies between install components can be defined in a Global Product Registry (GPR) xml file. In one embodiment the light weight package installer can be used on a computer running any operating system that has previously installed a Java Development Kit.

In one embodiment, the light weight package installer can offer a selection of Java Development Kits (JDKs) to install. The light weight package installer can include appropriate JDKs for the operating system of the target computer.

At installation scripts can be generated which point to installed Java Virtual Machines (JVMs). Scripts can be generated as per following rules:
1) If a user selects one of the JVMs, scripts will point to the selected JVM.
2) If a user selects multiple JVMs, scripts will be generated based upon current heuristic algorithm.
3) If a user tries to install one JVM after previously installing a different JVM, the generated scripts will not be modified. Instead a warning will be displayed indicating that the user needs to manually modify scripts in order to reflect the new JVM.

### Internet Installer

In one embodiment the light weight server installer is an internet installer. The internet installer can contain functionality to expose a set of downloadable software components and download those software components selected by the user over a network from a remote server and install them locally in a user-defined location. The internet installer can delay the actual download until the user has exercised his choice. The internet installer serves the needs of the users who do not want to download monolithic install bits before actually installing the product.

The internet installer can enable a user to download a small installer that then enables the user to select other application server options to install. For users who already have a suitable Java Development Kit (JDK) installed, the small installer download is on the order of 10 MB.

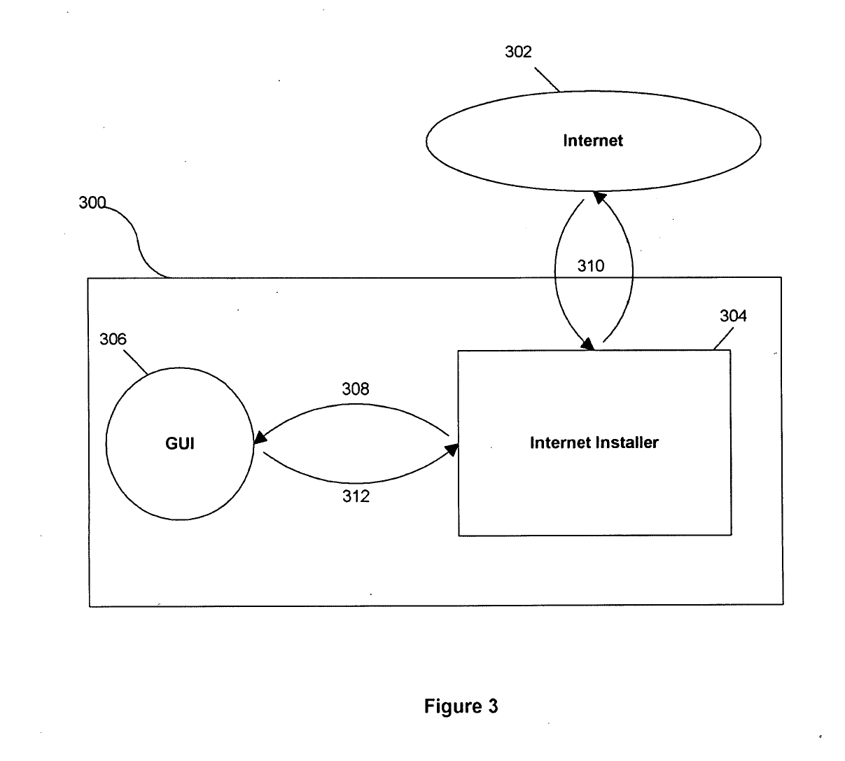

FIG. 3 shows an internet installer in accordance with an embodiment. The internet installer 304 can be downloaded 310 to computer 300 from the internet 302. The user can select 308 from among the selectable options presented using GUI 306. The internet installer downloads 310 only the install files corresponding to the selectable options selected by the user from the internet. The internet installer then installs only those selectable options selected by the user.

In one embodiment, JDK download and installation options can be selectable from the internet installer. In one embodiment, the internet installer can support downloading an installation of a core application server only. In one embodiment, the internet installer can also support the installation of additional components without unnecessarily re-downloading a JDK or other previously installed options.

In one embodiment, the internet installer can be used on any computer regardless of the operating system of the computer. In this embodiment the target computer already has a Java Runtime Environment (JRE) installed.

In another embodiment the internet installer can be configured to run only on a specific operating system. In this embodiment the internet installer installs a JRE on the target computer where the JRE is operating system specific.

### Installation Options

In one embodiment, the light weight server installer can install WebLogic Server by Oracle Corporation of Redwood Shores, Calif.

The installation options for Java Development Kits (JDKs) can include:
JRockit JDK by Oracle Corporation
Sun JDK by Sun Microsystems

The installation options for WebLogic server can include:
Core Application Server
Administration Console
Configuration Wizard and Upgrade Framework
Web 2.0 HTTP Pub/Sub Server
WebLogic Java Database Connectivity (JDBC) Drivers
Third Party JDBC Drivers
WebLogic Server Clients
WebLogic Web Server Plugins
Beehive and Struts libraries
Universal Description, Discovery and Integration (UDDI) and Xquery Support
Server Examples

In one embodiment, options under WebLogic Server can be dependent on Core Application Server. Core Application Server is not dependent on any options. In one embodiment, options besides Core Application Server are not dependent on each other. If a user selects any option beside Core Application Server, and Core Application Server is not already installed, then Core Application Server will automatically be installed. In one embodiment, the Server Examples option requires all options to be installed.

Other options parallel to WebLogic Server can include:
Workshop for WebLogic Platform
Guardian

Guardian can be dependent on WebLogic Server Core.

The above listed options are described in further detail below:

### JDKs

A Java Development Kit can include a Java runtime environment and tools and APIs for writing and running Java applications. The JDK the user selects can be the default JDK used to run WebLogic Server.
Sun JDK description: This JDK from Sun Microsystems can include many performance and reliability improvements along with expanded monitoring and diagnostics capacities.
JRockit JDK description: Oracle JRockit can be designed for optimal performance for Java applications in large-scale, enterprise-wide environments. It can include many performance, stability, and manageability enhancements, including JRockit Mission Control.

### WebLogic Server

Core Application Server description: Can implement Java Platform Enterprise Edition 5 (JEE5) technologies, Web Services, and other leading Internet standards to provide a reliable framework for highly available, scalable, and secure applications and services. Full set of components that comprise the essential WebLogic Server runtime with full JEE5 support. Does not include administration tools and add-on technologies, such as the Administration Console, Web Server plug-ins, Beehive runtime framework, JDBC drivers, and so forth.
Administration Console description: A Web browser-based, graphical user interface that the user can use to manage a WebLogic Server domain.
Configuration Wizard and Upgrade Framework description: Can guide the user through the process of creating a domain for the user's target environment by selecting the configuration options the user wants to include in the user's domain, or by using domain templates and Provides tools that convert a domain configuration from previous WebLogic Server releases to the current release.
Web 2.0 HTTP Publish/Subscribe Server: A channels based publish/subscribe mechanism for web based clients to send and receive asynchronous messages over HTTP. The HTTP Pub/Sub Server can be used by web clients to subscribe to channels (a representation in Bayeux for destinations) and publish messages to the channels. Developers are recommended to install the HTTP Pub/Sub sample by selecting the “Server Examples” checkbox from the installation options.
Oracle WebLogic JDBC Drivers description: These are WebLogic implementation of JDBC Drivers which are required by an application running a WebLogic server to connect to external database. This option includes Oracle implementation of those drivers.
Third Party JDBC Drivers description: These are 3^{rd} Party implementation of JDBC Drivers which are required by an application running on a WLS server to connect to external database. This option includes Oracle implementation of those drivers.
WebLogic Server Clients description: Thin client jars required to connect to a WebLogic server. For ex: Web Services client jar, any web services application would need a Web Services thin client jar on the client side instead of the entire WebLogic server
WebLogic Web Server Plugins description: This option includes WebLogic server proxy Plugins required by an HTTP server like Apache to connect to WebLogic server.
Beehive and Struts libraries: This option includes Beehive implementation and Struts libraries from Apache.
UDDI and Xquery support description: This option includes UDDI and UDDI Explorer applications. This option also includes an XQuery Engine. UDDI stands for Universal Description, Discovery and Integration. The UDDI Project is an industry initiative that is working to enable businesses to quickly, easily, and dynamically find and carry out transactions with one another. A populated UDDI registry contains cataloged information about businesses, the services that they offer and communication standards and interfaces they use to conduct transactions. Built on the Simple Object Access Protocol (SOAP) data communication standard, UDDI creates a global, platform-independent, open architecture space that will benefit businesses.
Server Examples description: Example applications that demonstrate key features of WebLogic Server. Selecting installation of examples will cause an evaluation database to be installed.

### Exemplary Embodiments

### Experienced Developer

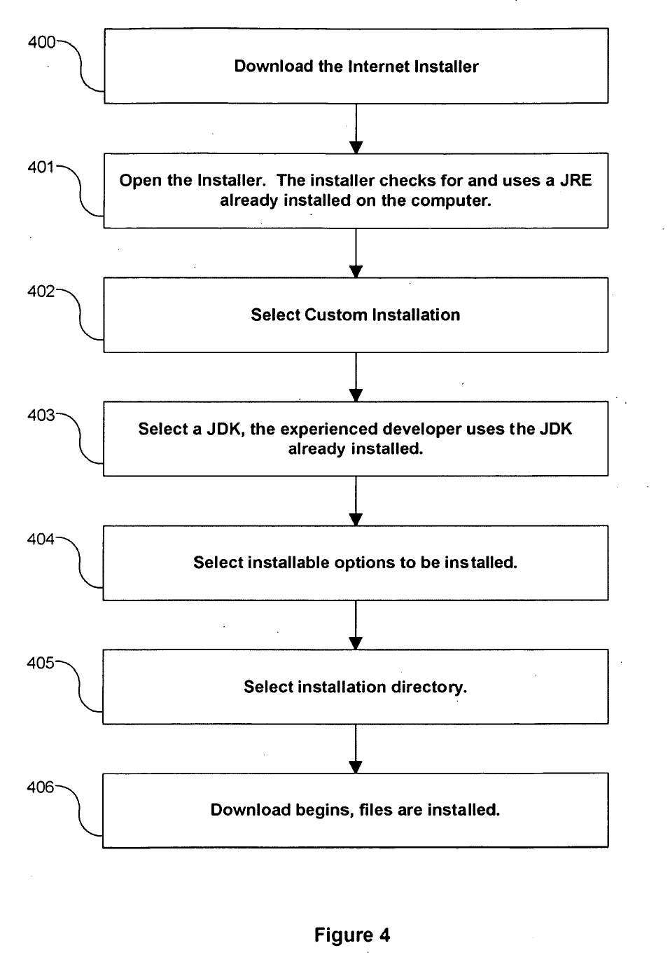

FIG. 4 shows a use case where an experienced developer is looking to install WebLogic Server. He wants only the parts of the WebLogic Server distribution that apply to him. His company uses Microsoft SQL Server, and he is starting on a new project that will include some new Rich Internet Applications (RIA). He already has Eclipse and he does not use Workshop.
Step 400. From the download center, select WebLogic Server Net Installer. A small download framework downloads.
Step 401. Open the installer. The installer checks for and uses a JRE installed on his computer.
Step 402. After the license agreement and Home location panels, select “Custom Installation.”
Step 403. JDK selection options are provided. The developer already has a suitable JDK installed, so he opts not to install any JDK.
Step 404. In the Products and Components Selection panel, the developer selects the following options:
   Core Application Server (99 MB)
   Web 2.0 Feature Pack (5 MB)
   Oracle WebLogic JDBC Drivers (2.3 MB)
      Total additional download size: 106.3 MB
Step 405. Select installation directory.
Step 406. Automatic download begins, then files are in stalled.

The following two use cases show experienced developers, similar to the one in FIG. 4, who have different needs and use the internet installer to install the appropriate components. In this use case the developer uses MySQL:
1. From the download center, select WebLogic Server Net Installer. A small download framework downloads.
2. Open the installer. The installer checks for and uses a JRE installed on his computer.
3. After the license agreement and Home location panels, select “Custom Installation.”
4. JDK selection options are provided. The developer already has a suitable JDK installed, so he opts not to install any JDK.
5. In the Products and Components Selection panel, the developer selects the following options:
   Core Application Server (99 MB)
   Web 2.0 Feature Pack (5 MB)
   Third-party JDBC Drivers (28.2 MB)
      Total additional download size: 132.2 MB (difference of 25.9 MB, or 24%)
6. Select installation directory.
7. Automatic download begins, then files are in stalled.

This developer uses Oracle and uses the Administration Console:
1. From the download center, select WebLogic Server Net Installer. A small download framework downloads.
2. Open the installer. The installer checks for and uses a JRE installed on his computer.
3. After the license agreement and Home location panels, select “Custom Installation.”
4. JDK selection options are provided. The developer already has a suitable JDK installed, so he opts not to install any JDK.
5. In the Products and Components Selection panel, the developer selects the following options:
   Core Application Server (99 MB)
   Administration Console (62.4 MB)
   Web 2.0 Feature Pack (5 MB)
      Total additional download size: 166 MB
6. Select installation directory.
7. Automatic download begins, then files are in stalled.

### Administrator

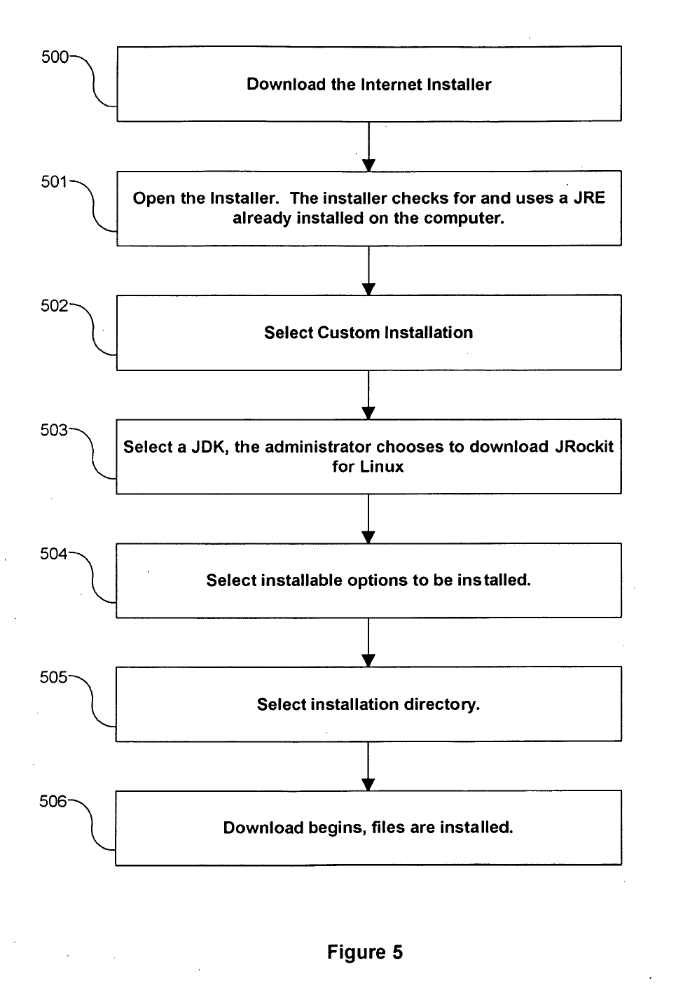

FIG. 5 shows a use case where an administrator is looking to install WebLogic Server.
Step 500. From the download center, select WebLogic Server Net Installer. A small download framework downloads.
Step 501. Open the installer. The installer checks for and uses a JRE installed on his computer.
Step 502. After the license agreement and Home location panels, select “Custom Installation.”
Step 503. JDK selection options are provided. The administrator selects the JRockit JDK 6 equivalent for Linux (the OS he is installing on).
Step 504. In the Products and Components Selection panel, the administrator selects the following options:
   JRockit JDK (129 MB)
   Core Application Server (99 MB)
   Administration Console (62.4 MB)
   Configuration Wizard and Upgrade Framework (9 MB)
   Web 2.0 Feature Pack (5 MB)
   Oracle WebLogic JDBC Drivers (2.3 MB)
   Web Server Plug-ins (70 MB)
      Total download size: 278 MB
Step 505. Select installation directory.
Step 506. Automatic download begins, then files are in stalled.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, it will be evident that while the examples described herein illustrate how the features may be used in a WebLogic environment, other application servers, virtual machines, computing environments, and software development systems may use and benefit from the invention.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for installing application servers comprising:
a light weight server installer; the light weight server installer includes a plurality of selectable options including a core application server and a plurality of optional components; the optional components include an administration console, at least one library, and at least one driver; and
wherein the light weight server installer installs only the selectable options selected by a user.

2. The system of claim 1 wherein the light weight server installer is an internet installer and further comprising:
wherein a user downloads the internet installer remotely; and
wherein the internet installer downloads only the selectable options which comprise the user's selection.

3. The system of claim 1 wherein the light weight server installer is an enhanced package installer and further comprising:
wherein the enhanced package installer contains all of the software necessary to install all selectable options, can be downloaded or delivered on a computer readable storage medium, and can be used to install additional selectable options in a subsequent installation; and
an enhanced package uninstaller, which enhanced package uninstaller can uninstall previously installed selectable options.

4. The system of claim 1 wherein the plurality of selectable options further includes a plurality of Java Development Kits (JDKs).

5. The system of claim 1 further comprising:
wherein at least one optional component has an interdependency with at least one other optional component; and
wherein the interdependency for the at least one optional component is defined in a product registry.

6. The system of claim 1 wherein the plurality of selectable options further includes a Java Runtime Environment (JRE), which JRE is operating system specific.

7. The system of claim 1 further comprising:
wherein a graphical user interface enables a user to select selectable options to be installed, displays information about each selectable option, and indicates the total disk space required for the installation of the selected selectable options.

8. The system of claim 1 further comprising:
wherein the light weight server installer can generate installation scripts which installation scripts point to installed Java Virtual Machines.

9. The system of claim 1 wherein the plurality of optional components includes at least one of:
Configuration Wizard;
Web 2.0 HTTP Pub/Sub Server;
Java Database Connectivity (JDBC) Drivers;
Server Clients;
Web Server Plugins;
Universal Description, Discovery and Integration (UDDI) and Xquery Support; and
Server Examples.

10. A method of installing application servers using a light weight server installer comprising:
receiving a selection from a plurality of selectable options; the plurality of selectable options including a core application server and a plurality of optional components wherein the plurality of optional components include an administration console, at least one library and at least one driver; and
installing the selection of selectable options.

11. The method of claim 10 wherein the light weight server installer is an internet installer and further comprising:
downloading the internet installer remotely; and
downloading only the selection of selectable options.

12. The method of claim 10 wherein the light weight server installer is an enhanced package installer and further comprising:
wherein the enhanced package installer contains all of the software necessary to install all selectable options, can be downloaded or delivered on a computer readable storage medium, and can be used to install additional selectable options in a subsequent installation.
selecting from a plurality of installed options in an enhanced package uninstaller resulting in a selection of installed options;
wherein the plurality of installed options includes previously installed options from the plurality of selectable options; and
uninstalling the selection of installed options.

13. The method of claim 10 further comprising:
wherein at least one optional component has an interdependency with at least one other optional component; and
wherein the interdependency for the at least one optional component is defined in a product registry.

14. The method of claim 10 wherein the plurality of selectable options further includes a plurality of Java Development Kits (JDKs),

15. The method of claim 10 wherein the plurality of selectable options further includes a Java Runtime Environment (JRE), which JRE is operating system specific.

16. The method of claim 10 wherein selecting from a plurality of selectable options comprises:
making selections in a graphical user interface wherein the graphical user interface enables a user to select selectable options to be installed, displays information about each selectable option, and indicates the total disk space required for the installation of the selected selectable options.

17. The method of claim 10 further comprising:
generating installation scripts which installation scripts point to installed Java Virtual Machines.

18. The method of claim 10 wherein the plurality of optional components includes at least one of:
Configuration Wizard;
Web 2.0 HTTP Pub/Sub Server;
Java Database Connectivity (JDBC) Drivers;
Server Clients;
Web Server Plugins;
Universal Description, Discovery and Integration (UDDI) and Xquery Support; and
Server Examples.

19. A computer readable medium, including instructions stored thereon which when executed cause the computer to perform the steps of:
receiving a selection from a plurality of selectable options; the plurality of selectable options includes a core application server and a plurality of optional components wherein the plurality of optional components includes an administration console, at least one library and at least one driver; and installing the selection of selectable options.

20. The computer readable medium of claim 19 wherein the light weight server installer is an enhanced package installer and further comprising:
wherein the enhanced package installer contains all of the software necessary to install all selectable options, can be downloaded or delivered on a computer readable storage medium, and can be used to install additional selectable options in a subsequent installation.
selecting from a plurality of installed options in an enhanced package uninstaller resulting in a selection of installed options;
wherein the plurality of installed options includes previously installed options from the plurality of selectable options; and
uninstalling the selection of installed options.
